(19) United States
(12) Patent Application Publication
(10) Pub. No.: US 2011/0245057 A1
(43) Pub. Date: Oct. 6, 2011

(54) ENVIRONMENTAL BAG RECYCLING SYSTEM

(76) Inventors: JIM SCOLEDES, Islamorada, FL (US); Brendan Barba, Franklin Lakes, NJ (US)

(21) Appl. No.: 12/752,892

(22) Filed: Apr. 1, 2010

(51) Int. Cl. B31B 1/14; C08K 11/00

(52) U.S. Cl. 493/227; 523/125

(57) ABSTRACT

A system comprising using at least one recycled plastic to create a polymer film, infusing the film with at least one color additive, infusing the film with at least one scent additive, infusing the film with at least one dormant microbe, cutting and folding the film to create at least one bag, using the bag as a shopping bag, using the bag as a trash bag, and activating the microbe to decompose the bag. The system wherein the bag further comprise at least one handle adapted to receive at least one tongue, at least one polymer film is selected from the group consisting of low density polyethylene and equivalents, and the dormant microbe is infused onto the film by a method selected from the group consisting of spraying, and equivalents. Wherein the dormant microbe is selected from the group consisting of Pseudomonas, Sphingomonas and combinations thereof.

### FIELD OF THE INVENTION

The present invention relates to the art of bagging and recycling.

### CROSS REFERENCE TO RELATED APPLICATIONS

Not applicable.

### STATEMENT REGARDING FEDERALLY-SPONSORED RESEARCH AND DEVELOPMENT

Not applicable.

### BACKGROUND OF THE TECHNOLOGY

Plastic bags have made our lives easier in many ways. Unfortunately, they are often not disposed of properly. We see them blowing around in the streets and they often end up in streams and the oceans. These bags can be dangerous to animals, which ingest them or are strangled by them, especially in marine environments where plastic bags resemble jellyfish and other food items.

In the developed countries of the world, each human uses an average 200 pounds of plastic annually. According to industry estimates, the use of plastic resins is likely to grow from 48 billion lb/yr in 1985 to 82 billion lb/yr by the year 2008. By far, the single largest consumer of plastics is packaging: films, bottles, and other rigid containers, as well as coatings and closures. Together, low-density polyethylene, high-density polyethylene, and polystyrene account for 75 percent of the plastic resins used in packaging.

While a tiny amount of the garbage is recycled into durable goods, about half the plastic we produce ends up in landfills, and the rest of it becomes lost in the environment and ultimately washes out to sea, to become trapped in heavily polluted oceans, negatively affecting ocean life and humanity.

One solution to this problem is to make biodegradable bags by incorporating a hydrocarbon-degrading microorganism into the manufacturing process. Feasible microorganisms for such a process are bacteria from the genus, Pseudomonas. Pseudomonas is a genus of gamma proteobacteria belonging to the larger family of pseudomonads. A modified version of the pseudomonas bacterium has been shown to be able to decompose styrene, which is recovered by pyrolysis (thermal decomposition in the absence of oxygen) of styrofoam (polystyrene), and to convert it into polyhydroxyalkanoates (PHA), which are themselves useful plastics, e.g. in medical procedures, but are biodegradable. This solution has not been commercially feasible since the manufacturing is very expensive. Furthermore, these bags are not resilient enough to be used several times and carry the loads of an average shopper.

Another solution is to add an ultraviolet-light absorber to make the material degrade when exposed to sunlight. Although very pure polymers are not susceptible to the sun's radiation, plastics, in actuality, contain molecular irregularities that cause them to absorb UV light. These impurities underlie the technology of photodegradation, whereby photosensitive additives introduced during processing enhance polymer breakdown. Unfortunately, once plastic hits landfills and is covered with dirt, hidden from the sun's UV rays, there is nothing to break the polymer molecules down forever.

Plastic bags have been around for more than 100 years, and they will be around for many more. Without a doubt, plastic bags are extremely useful. However, when it comes to shopping, some environmentally conscious consumers prefer to avoid plastic bags, opting instead for paper bags, or even cloth bags. The reality is that most consumers do not carry cloth bags or use paper bags because they do not hold as much weight or they are difficult to carry. Thus, the convenience of polymer plastic bags remains despite the harsh environmental price the earth pays.

There is a need in today's marketplace to have a method to be able to use less polymer plastic bags and eradicate garbage bags for future generations. A bag is needed that breaks-down, even if they are buried under ground in landfills. Moreover, in the bagging industry, it would be desirable to progress from the environmentally unforgiving bag, to a system that encourages consumers to re-use bags, and thus limiting the environmental footprint.

### BRIEF DESCRIPTION OF THE SEVERAL VIEWS OF THE DRAWINGS

The foregoing summary, as well as the following detailed description of the technology, will be better understood when read in conjunction with the appended drawings. For illustrating the technology, the figures are shown in the embodiments that are presently preferred. It should be understood, however, that the technology is not limited to the precise arrangements and instrumentalities shown. In the drawings:

FIG. 1 depicts at least one embodiment of one element of the system, namely recycled polymer based plastic.

FIG. 2 depicts at least one embodiment of one element of the system, namely the manufacturing process of sorting, melting, rolling, adding the biodegradable pigment, cutting, and rolling of the invention to make a plastic film.

FIG. 3 depicts at least one embodiment of one element of the system, namely to die cut or heat cut at least one biodegradable plastic bag.

FIG. 4 depicts at least one embodiment of one element of the system, namely to use the bag as a carrying bag.

FIG. 5 depicts at least one embodiment of the system, the extension of hidden handles.

FIG. 6 depicts at least one embodiment of one element of the system, namely to insert the biodegradable bag into a container comprising of at least one tongue.

FIG. 7 depicts at least one embodiment of one element of the system, namely to use the biodegradable bag as a garbage bag.

FIG. 8 depicts at least one embodiment of the system, the tightening of the now biodegradable garbage bag using four handles.

FIG. 9 depicts at least one embodiment of one element of the system, namely to have the biodegradable bag disintegrate into the environment.

FIG. 10 depicts at least one embodiment of one element of the system, namely a biodegradable bag with two hidden handles.

FIG. 11 depicts at least one embodiment of one element of the system, namely to have the handles reinforced by adding more plastic material in a gusseted carrying bag.

FIG. 12 depicts at least one embodiment of one element of the system, namely to have handles reinforced by creating a double seam on the plastic material and a straight seal.

FIG. 13 depicts at least one embodiment of one element of the system, namely a star-sealed carrying bag and reinforced handles.

FIG. 14 depicts at least one embodiment of one element of the system, namely a carrying bag comprising four holes adapted to receive a container with our tongues.

FIG. 15 depicts at least one embodiment of one element of the system, namely a container adapted to receive the biodegradable carrying bag.

FIG. 16 depicts at least one embodiment of one element of the system, namely a round shaped container adapted to receive the carrying bag.

FIG. 17 depicts at least one embodiment of one element of the system, namely a square-shaped container adapted to receive the carrying bag.

FIG. 18 depicts a cross-section of at least one embodiment of one element of the system, namely the angular shape of at least one tongue.

FIG. 19 depicts at least one embodiment of one element of the system, namely a square-shaped container with external tongues.

FIG. 20 depicts at least one embodiment of one element of the system, namely a square-shaped tongues.

FIG. 21 depicts at least one embodiment of one element of the system, namely a square-shaped container with exchangeable internal and external tongues.

FIG. 22 depicts at least one embodiment of one element of the system, namely a square-shaped container with exchangeable internal and external tongues.

FIG. 23 depicts at least one embodiment of one element of the system, namely hinge type internal and external tongue.

### DESCRIPTION OF THE TECHNOLOGY

The present technology depicts an inventive solution to the fore mentioned issues related to environmental recycling systems and bags.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art. As appropriate, procedures involving the use of commercially available kits and reagents are generally carried out in accordance with manufacturer defined protocols and/or parameters, unless otherwise noted.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, or should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. one or the other but not both“) when preceded by terms of exclusivity, such as “either,” one of,” “only one of,” or “exactly one of.” “Consisting essentially of,” when used in the claims, shall have its ordinary meaning as used in the field of patent law.

As used herein, the terms “microbe” and “bacteria,” can be used interchangeably and refer to one or more bacteria cells. The bacteria can be of any strain known to degrade hydrocarbon materials, such as low-density polyethylene (LDPE), high-density polyethylene (HDPE), and polystyrene. Likewise, one or more different strains of bacteria can be mixed to provide for the microbes of this invention. Preferred strains are of the genus Pseudomonas and Sphingomonas. A non-limiting representative list of preferable strains of Pseudomonas include Pseudomonas putida and Pseudomonas echinoides. Also, the bacteria can include cultures manipulated with DNA plasmids, e.g. to elicit improved hydrocarbon degradation.

As used herein, the term “plastic,” “bag” and “plastic bag,” can be used interchangeably and refer to as organic plastics are polymers, composed of monomers (repeating units). A polymer is a chain of molecules repeated again and again. Different kinds of monomers produce different kinds of “plastics”. All organic plastics used herein include a long backbone of carbon. Some “plastics,” such as polystyrene, are composed of monomers that contain only carbon and hydrogen. Other kinds of “plastics” used herein are “functionalized” with a wide variety of other kinds of atoms either present in the original monomer, or added later after polymerization. Nevertheless, most plastics used herein are made from petrochemicals (crude oil and natural gas), although they can also be produced from corn and other biomasses. Petrochemicals are used by chemical plants to make a wide variety of products such as fertilizers and plastic resins. Plastic resins are, in turn, used to produce many different types of “plastics.”

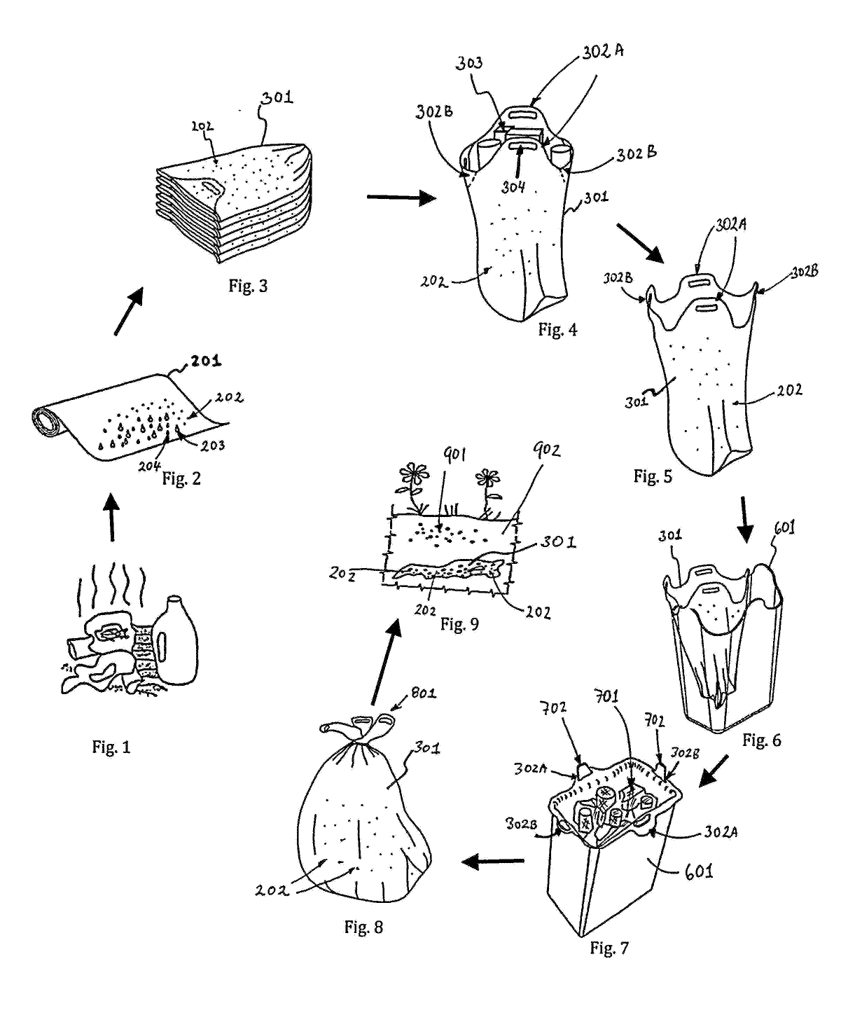

The invention described in FIG. 1 to FIG. 7, comprises a system to reduce the environmental footprint of shopping bags, and thus solving the issues described above. The ingenious system begin in FIG. 1, by using at least one plastic to create a low density polyethlyene film 201. The plastic may come from a recycled source FIG. 1 to further reduce the environmental impact. This film 201 is later coated or infused with at least one die 204, at least one scent 203, and/or at least one microbe 202. One of the embodiments is that the microbe 202 be in a dormant state. The term “dormant” or “dormant cells,” as used herein, is intended to describe cells that are in a state which are required to be activated before they can undergo growth. For bacteria, this is sometimes called a sporulated (spore) state. The microbes are induced into dormancy by any acceptable means known by those skilled in the art.

As used herein, the term “infuse” or “coat,” can be used interchangeably and refer to as to put into or introduce (a solution) as if by pouring, to fill or cause to be filled with something, to steep or soak, to flavor or scent (a liquid) by steeping ingredients in it. In addition, the film 201 can be “coated,” covered, spread, plastered, smeared with various enzymes and/or buffering solutions to help retain viability of the at least one microbe 202 and/or assist the microbe 202 in degradation of the plastic material once the microbe exits dormancy.

By providing the microbes 202 in a dormant state, the microbes 202 are protected from environmental factors which may have detrimental effects on active microbes. In bacteria, for example, the environmental factors may include low moisture or humidity, as the surface of the plastic may generally be kept in a dry state. Other factors include exposure to heat, chemical agents, and UV radiation from sunlight, as well as the exposure of air for strains of bacteria that may be anaerobic. Once the dormant microbes 202 are introduced into the soil, the environmental factors would be ideal for the cells to exit their dormant state and begin to grow and replicate and begin the process of consuming and degrading the plastic.

The microbe 202 preparation was provided as an aqueous preparation of a suspension of a Pseudomonas species and one or more adhering agents in a suitable aqueous carrier, such as distilled water, tap water, a buffered saline solution or other such aqueous solutions. The adhering agents were utilized to keep the microbe 202 associated with the surface of the plastic and remain associated with the surface during normal usage of the plastic. The adherence of the microbe 202 to the plastic layer is such that it is associated with the surface of the plastic while remaining exposed so that the dormant microbe may be activated upon exposure to a soil environment. The adhering agent can be a styrene butadiene rubber, nitrile rubber, an acrylic polymer, polyvinyl chloride and combinations thereof. Other appropriate adhering agents may be employed as would be understood by those skilled in the art.

The coating steps of the process may be done in any method that allows the surface to be treated with the preparation. The preparation may be dipped or sprayed or rolled onto the surface of the plastic. Also, the step could include applying the coating by dipping the plastic into a bath containing the appropriate adhering agent and/or buffers and fillers.

The film is later cut to size, sealed and folded, FIG. 3 to create plastic bag 301. The system continues with FIG. 4, at least one user employs the plastic bag 301 to carry items 303 from the marketplace to at least one other place using pre-cut handles 302A. As FIG. 5 depicts, the user later unfolds the folded handles 302B and places it in a container 601, as seen in FIG. 6 the container comprise several tongues 702 adapted to receive the bag 301, giving it yet another use as a garbage bag 301, for any type of garbage 701 as shown in FIG. 7. The final step in the system is that, as the now closed 801 garbage bag FIG. 8 gets buried in a landfill 902, components in the soil 901 will interact with the microbes 202 and/or enzymes deposited in FIG. 2 on the bag 301, and the bag 301 will decompose into the earth as shown in FIG. 9.

Plastics are composed of polymers—large carbon-hydrogen molecules consisting of repeating units called monomers. In the case of plastic bags, the repeating units are ethylene, or ethene. When ethylene molecules are polymerized to form polyethylene, they form long chains of carbon atoms in which each carbon also is bonded to two hydrogen atoms. The plastic bag 301 herein is made out of LDPE. HDPE could also be used for the same purpose to accomplish the same result, since the molecules have a similar structure to LDPE. The main difference is that HDPE does not allow light to pass through.

LDPE is one of the most widely used packaging materials in the market. It is low in cost compared to wood and metal. It is very tough, flexible, a barrier to moisture, chemical resistant, and lightweight. Sixty-five percent of the LDPE used in the world is for films and sheets to make garbage bags, grocery sacks, garment bags, shrink film, stretch film, pond liners, construction and agriculture film and food packaging. As would be understood by those skilled in the art, the application of the invention described herein could apply to other uses of plastics aside from bags. Application of this invention could include other uses where the plastics are eventually disposed of and degradation is necessary.

As the machine melts the LDPE to make the molten slurry, additives, such as colored die 203, are placed in the slurry before rolling and hardening. Colored die 203 can also be printed onto the film. In manufacturing FIG. 2, the “bag machine” in the factory making the bags 301 must arrange the molecules of LDPE in a certain direction, thus placing the molecular chains in the direction appropriate to make the bag stronger. After the roll of LDPE is made, scent 204 is sprayed in a fine mist and added as the roll LDPE passes. This is to give the bag a pleasant odor in order to camouflage the garbage smell. In one embodiment of the invention, the last ingredient, before cutting to size, is the addition of dormant microbes 202.

The invention herein comprises an innovative biodegradable system designed to do the following: first, to utilize already recycled plastics, LDPE and HDPE, to create the plastic film 201; second, to add carbon-hydrogen consuming bacteria (such as Pseudomonas) 202 to create a new biodegradable bag 301; third, to use the biodegradable bag 301 as a shopping bag FIG. 4; fourth, to use the biodegradable bag as a garbage bag FIG. 6 and FIG. 7; and finally, to have the bag biodegrade by activating the bacteria 202 as it is disposed underground FIG. 9.

The typical garbage bag is not soluble in water and resists degradation from microbial action or the effects of sunlight and oxygen. Paradoxically, it is this same indestructibility, which makes plastics so useful, and creates such a problem in the environment. Polymers degrade mainly by a combination of two mechanisms: photodegradation, in which ultraviolet (UV) radiation causes the material to become brittle and eventually degrade; and chemical degradation, in which the material falls apart as a result of oxidation or loss of molecular weight. Unfortunately, when a plastic bag is disposed of underground, such as in a landfill, neither oxygen nor light is available to help in the degradation.

A polymer incorporating dormant microbes 202 is one element of a systematic solution to the environmental issue. Adding dormant microbes 202 can be competitive in pricing when it is mixed or sprayed onto plastic resin, and microbe-based composites can be processed on the same equipment as conventional plastics. Likewise, the hydrocarbon-degrading Pseudomonas can digest about two-thirds of the hydrocarbons without needing oxygen, and thus the perfect solution to the bag 301 in a landfill FIG. 9 problem. The dormant microbe-based degradable plastic 301 herein may have other commercial applications in polyethylene, such as bags for household and yard waste, and in diapers with biodegradable liners. The system described in FIG. 1 to FIG. 9 is the complete solution to the environmental recycling issue because it converts non-degradable polymers FIG. 1 to degradable polymers FIG. 3, and consumers may utilize the bags multiple times FIG. 4-FIG. 7 before disposal FIG. 9.

In one embodiment of the invention, typical LDPE and HDPE solutions contain about 0.06 percent by volume of Pseudomonas. In other embodiments, the LDPE and HDPE solutions may contain greater than 0.06 percent by volume of Pseudomonas, depending on the applicability of the plastics and the manufacturing and processing capabilities. In addition, oxidizing agents can be added to enhance breakdown of the polymer chain. In order to be viable in a high-volume market like packaging, a biodegradable bag 301 must be cost-competitive with existing resins and must be amenable to fabrication by injection molding or melt extrusion into films.

In the inventive process herein, the degradation is accelerated by the incorporation of dormant microbes 202. The dormant microbes are “awakened” to resume normal activity and replication by proper environmental conditions and/or other active microbes 901 in the vicinity of the dormant microbial cells 202. Once at the landfill FIG. 9, metabolically active cells 901 can react with dormant cells 202, creating a biologically active environment FIG. 7. The active microbes consume the LDPE chains through enzymatic processes and the byproduct is further consumed by other microorganisms, leaving shorter polymer chains behind. This weakens the LDPE and increases its surface area for further degradation. The carbon chain-eating bacteria, such as Pseudomonas, have been evolved and bioengineered to consume hydro-carbon chains, the major component of LDPE.

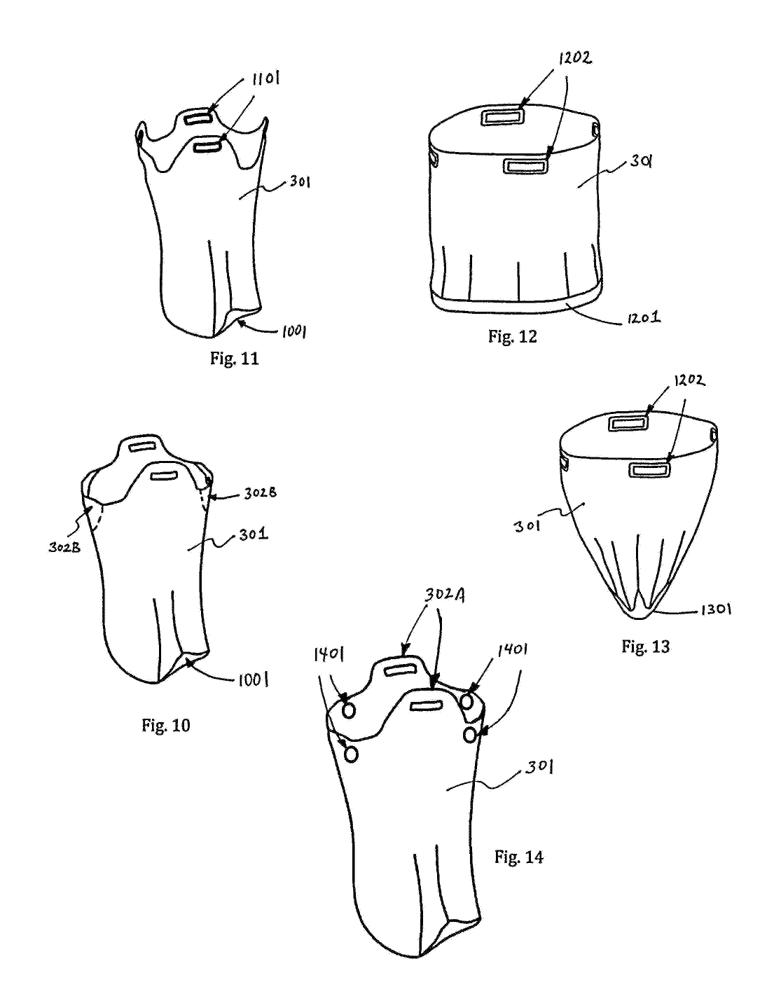

In one element of the system of the technology, the bag in FIG. 10 and FIG. 11 is a gusseted type bag with a gusseted seal 1001 and reinforced handles 1101. Other types of bags can be used for the same purpose to accomplish the same results—for instance, bag types such as the straight seam 1201 sealed bag on FIG. 12 or the star sealed 1301 bag of FIG. 13. Any type of reinforcement can be used for the handle openings 304, such as making the edge of the opening thicker by adding more material 1202 or simply heating up and melting the plastic to make it stronger 1101. One of the inventive features of the bag 301 herein, is the addition of at least two extra handles 302B, which act as the female element for a pairing receiving container's 601 male elements 702.

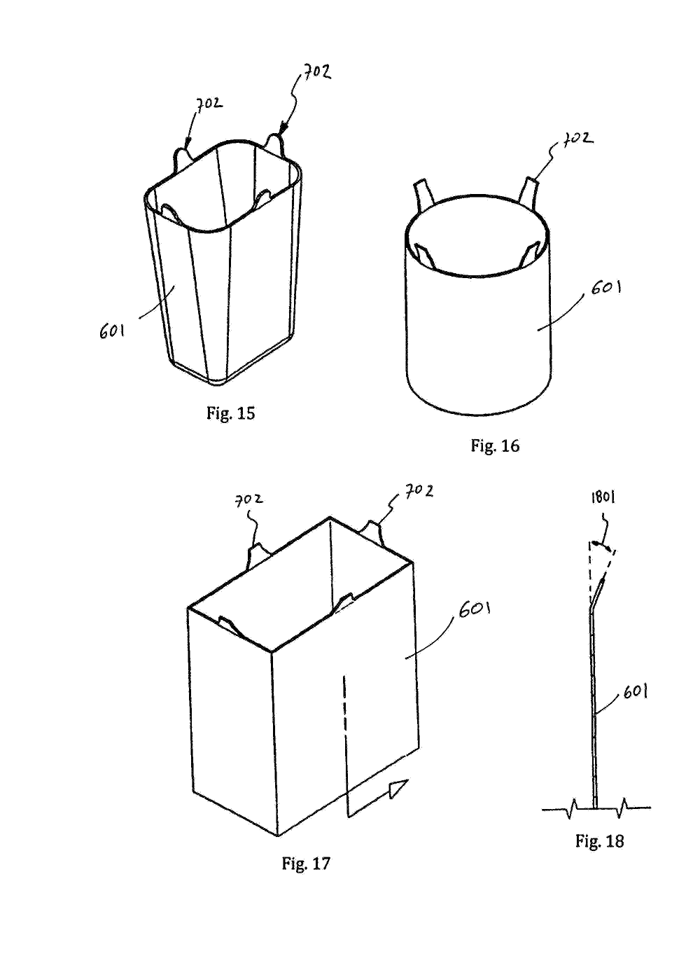

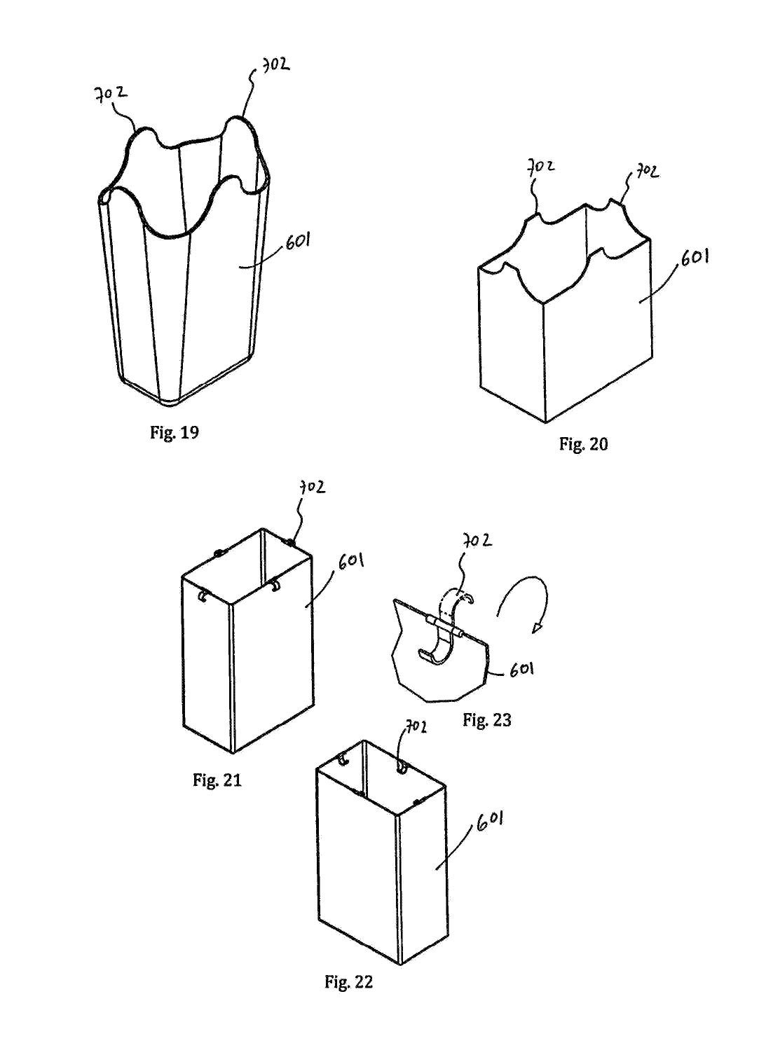

In one element of the system of the technology, the receiving container 601 can be made of many materials and have many shapes, such as FIG. 15, FIG. 16 or FIG. 17. Many forms of containers and materials, including metals and non-metals alike, serve the same purpose to accomplish the same result. The receiving container 601 comprises at least one set of tongues 702 that match the openings 304 and are adapted to receive the degradable bag openings 304 on handles 302A and 302B. The invention herein is not limited to four openings 304 or handles 302A, 302B. It is understood that the person skilled in the art may add more or use less openings and handles for the same purpose to accomplish the same result. In another embodiment of the invention, for example, four round openings 1401, as seen in FIG. 14, can be stamped out or die cut, they can also be used for the same purpose to accomplish the same result.

The inventive tongues 702 may also be made of many materials and be disposed at any angle 1801 from 0 to 180 degrees. FIG. 17 and FIG. 18 depicts that the receiving container and the angled receiving tongues 702 used to keep the degradable bag 301 from falling into the container. The inventive tongues may also be in shape of hooks, placed externally, such as in FIG. 21 or internally, such as tongue 702 in FIG. 22. Alternatively, a hinge tongue 702, as seen in FIG. 23 can be used. This form of tongue would work both inside and outside of the receiving container 601.

It will be appreciated by those skilled in the art that changes could be made to the embodiments described above without departing from the broad inventive concept thereof. It is understood, therefore, that this technology is not limited to the particular embodiments disclosed, but it is intended to cover modifications within the spirit and scope of the present technology.

We claim:

1. A system comprising:
using at least one recycled plastic to create a polymer film,
infusing said film with at least one color additive,
infusing said film with at least one scent additive,
infusing said film with at least one dormant microbe,
cutting and folding said film to create at least one bag,
using said at least one bag as a shopping bag,
using said at least one bag as a trash bag, and
activating said microbe to decompose said at least one bag.

2. The system of claim 1, wherein said at least one bag further comprise at least one handle adapted to receive at least one tongue.

3. The system of claim 1, wherein said at least one polymer film is selected from the group consisting of low density polyethylene, linear low density polyethylene, high density polyethylene and combinations thereof.

4. The system of claim 1, wherein said at least one polymer film is selected from the group consisting of a mono layer film, a co-extruded film and combinations thereof.

5. The system of claim 1, wherein said at least one bag is selected from the group consisting of star sealed, gusseted, lay flat, side sealed and combinations thereof.

6. The system of claim 1, wherein said at least one dormant microbe is infused onto the film by a method selected from the group consisting of spraying, mixing, wiping, dipping, rolling, bathing and any combination thereof.

7. The system of claim 1, wherein said at least one trash bag is adapted to be used with a container that comprises at least one tongue.

8. The system of claim 1, wherein said at least one dormant microbe is activated by contact or vacinity with soil.

9. The system of claim 1, wherein said at least one dormant microbe is selected from the group consisting of Pseudomonas, Sphingomonas and combinations thereof.

10. The system of claim 1, wherein said at least one dormant microbe is selected from the group consisting of Pseudomonas putida and Pseudomonas echinoides.

11. The system of claim 1, wherein said at least one dormant microbe-enzyme is activated by adding at least one active microbe.

12. The system of claim 1, wherein said at least one dormant microbe is activated by adding moisture and heat.

13. A decomposable film comprising:
at least one plastic
and
at least one dormant microbe.

14. The film of claim 13, wherein said at least one dormant microbe is activated by adding moisture and/or heat.

15. The film of claim 13, wherein said at least one dormant microbe is activated by adding at least one active microbe.

16. The film of claim 13, wherein said at least one dormant microbe is selected from the group consisting of Pseudomonas, Sphingomonas and combinations thereof.

17. The film of claim 13, wherein said film is molded into least one bag that further comprises at least one handle adapted to receive at least one tongue.

18. The film of claim 13, wherein said plastic is selected from the group consisting of low density polyethylene, linear low density polyethylene, high density polyethylene and combinations thereof.

19. The film of claim 13, wherein said film is selected from the group consisting of mono layer films, co-extruded films and combinations thereof.

20. A system comprising:
using at least one recycled plastic to create a polymer film and
infusing said film with at least one dormant microbe.
